(19) United States
(12) Patent Application Publication
(10) Pub. No.: US 2026/0332253 A1
(43) Pub. Date: Oct. 22, 2026

(54) MULTI-PATH INTERFERENCE (MPI) DETECTION AND LOCALIZATION

(71) Applicant: MaxLinear, Inc., Carlsbad, CA (US)

(72) Inventors: Sridhar Ramesh, Carlsbad, CA (US); Zekeriyya Esat Ankarali, Irvine, CA (US)

(73) Assignee: MaxLinear, Inc., Carlsbad, CA (US)

(21) Appl. No.: 19/651,549

(22) Filed: Apr. 17, 2026

Related U.S. Application Data
(60) Provisional application No. 63/792,839, filed on Apr. 22, 2025.

(51) Int. Cl. H04B 10/071; H04L 43/067; H04L 43/0811; H04L 43/0852

(52) U.S. Cl. CPC H04B 10/071; H04L 43/067; H04L 43/0811; H04L 43/0852

(57) ABSTRACT

A method for multi-path interference (MPI) detection and localization may include one or more of: measuring a path delay of a signal; mapping the path delay to a connector-pair distance; or computing a reflection location based on the connector-pair distance. A device may include a processing device operable to perform the method. A system may include a pluggable module and an on-board component.

### RELATED APPLICATION

This application claims the benefit of U.S. Provisional Application No. 63/792,839, filed Apr. 22, 2025, the disclosure of which is incorporated herein by reference in its entirety.

### FIELD

The examples discussed in the present disclosure are related to multi-path interference (MPI) detection and localization.

### BACKGROUND

Unless otherwise indicated herein, the materials described herein are not prior art to the claims in the present application and are not admitted to be prior art by inclusion in this section.

In a wired communications network, pairs of connectors in the link may cause a reflection that combines with the intended signal and receiver (RX) receives the sum. These reflections are called multi-path interference (MPI).

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a method for multi-path interference (MPI) detection and localization may include: measuring a path delay of a signal; mapping the path delay to a connector-pair distance; and/or computing a reflection location based on the connector-pair distance.

In some examples, a device may include a processing device. The processing device may measure, at the device, a path delay of a signal; map, at the device the path delay to a connector-pair distance; and/or compute, at the device, a reflection location based on the connector-pair distance.

In some examples, a system may include a pluggable module and an on-board component. The pluggable module may include a retimed transmitter and one or more of a retimed receiver or a linear receiver. The on-board component may include a system application-specific integrated circuit (ASIC). One or more of the pluggable module or the on-board component may: measure a path delay of a signal, map the path delay to a connector-pair distance, and/or compute a reflection location based on the connector-pair distance.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example of multi-path interference (MPI) between a transmitter and a receiver.

FIG. 2 illustrates an example of MPI between a transmitter and a receiver.

FIG. 3 illustrates an example test transmitter.

FIG. 4 illustrates an example of MPI.

FIG. 5 illustrates an example of data capture.

FIG. 6 illustrates an example of different algorithms used for data-to-error correlation or capture-to-capture correlation.

FIG. 7 illustrates an example of a fixed width slicer algorithm.

FIG. 8 illustrates an example of a sub-window cross correlation and averaging algorithm.

FIG. 9 illustrates an example MPI search coverage expansion algorithm.

FIG. 10 illustrates an example algorithm flow.

FIG. 11A illustrates an example retimed pluggable module for MPI detection and localization.

FIG. 11B illustrates an example half-retimed pluggable module with an on-board retimer for MPI detection and localization.

FIG. 11C illustrates an example half-retimed pluggable module for MPI detection and localization.

FIG. 12 illustrates a process flow of MPI detection and localization.

FIG. 13 illustrates a block diagram of an example system operable to perform MPI detection and localization.

FIG. 14 illustrates a diagrammatic representation of a machine in the example form of a computing device within which a set of instructions, for causing the machine to perform any one or more of the methods discussed herein, may be executed.

### DESCRIPTION

In wired communication systems such as fiber-optic links and other communication paths, signal reflections may occur at interfaces between components such as connectors. The reflections may be directed along different paths and may combine with an intended signal at a receiver. The resulting interference may degrade signal quality, increase error rates, and impair receiver performance.

Multi-path interference (MPI) may result from multiple reflective locations along a link. Reflections associated with different connector pairs may lead to different path delays and interference levels which may make it difficult to determine which physical location is contributing to the impairment. This difficulty may increase when multiple connectors are present, when reflections vary over time, or when a faulty connector is to be detected without inspection of an entire link.

Merely detecting the presence of interference by itself may not provide the source of reflection or distinguish between different connector pairs. Therefore, it may be useful to provide enhanced techniques for detecting and localizing MPI in communication links. An MPI detection algorithm may detect the existence, location/delay & power of such reflections e.g., between connector pairs.

Examples of the present disclosure will be explained with reference to the accompanying drawings.

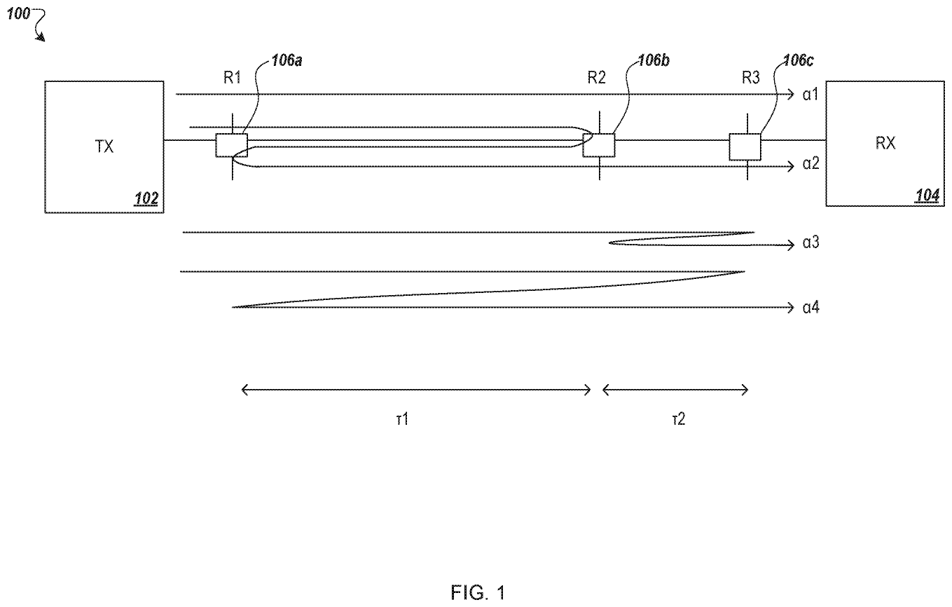

In some examples, FIG. 1 illustrates an example 100 of multi-path interference (MPI) between a transmitter 102 and a receiver 104. The system may have 3 connectors—R1 106a, R2 106b, and R3 106c. The distance between R1 106a and R2 106b may be τ1. The distance between R2 106b and R3 106c may be τ2. The distance between R1 106a and R3 106c may be τ1+τ2.

MPI between the transmitter 102 and the receiver 104 may be described using various computations. For example, α₁ may be described using: α₁=s(t−τ1−τ2) α₁ e^{-jω(τ1+τ2)}e^{-jφ(t-τ1-τ2)}. For example, α₂ may be described using: α₂=s(t−3τ1−τ2) α₂ \sqrt{R1R2}e^{-jω(3τ1+τ2)}e^{-jφ(t-3τ1-τ2)}. For example, α₃ may be described using: α₃=s(t−τ1−3τ2) α₂ \sqrt{R2R3}e^{-jω(τ1+3τ2)}e^{-jφ(t-τ1-3τ2)}. For example, α₄ may be described using: α₄=s(t−3τ1−3τ2) α₄ \sqrt{R1R3}e^{-jω(3τ1+3τ2)}e^{-jφ(t-3τ1-3τ2)}. S(t) may be the signal amplitude at time t. φ(t) may be the laser phase at time t. R1, R2, R3 may be the connector return losses. τ1 and τ2 may be the path delays.

The MPI reflection path length may be the length of extra path that MPI takes. For example, for α₁ in FIG. 1, the MPI reflection path length may be 0 because there may not be an extra path that MPI takes. For example, for α2 in FIG. 1, the MPI reflection path length may be twice the distance between R1 and R2 because the MPI is directed from R2 back to R1 and back to R2 before being directed to the receiver 104. For example, for α3 in FIG. 1, the MPI reflection path length may be twice the distance between R2 and R3 because the MPI is directed from R3 back to R2 and back to R3 before being directed to receiver 104. For example, for α4 in FIG. 1, the MPI reflection path length may be twice the distance between R1 and R3 because the MPI is directed from R3 back to R1 and back to R3 before being directed to the receiver 104.

Modifications, additions, or omissions may be made to the components of FIG. 1 without departing from the scope of the present disclosure.

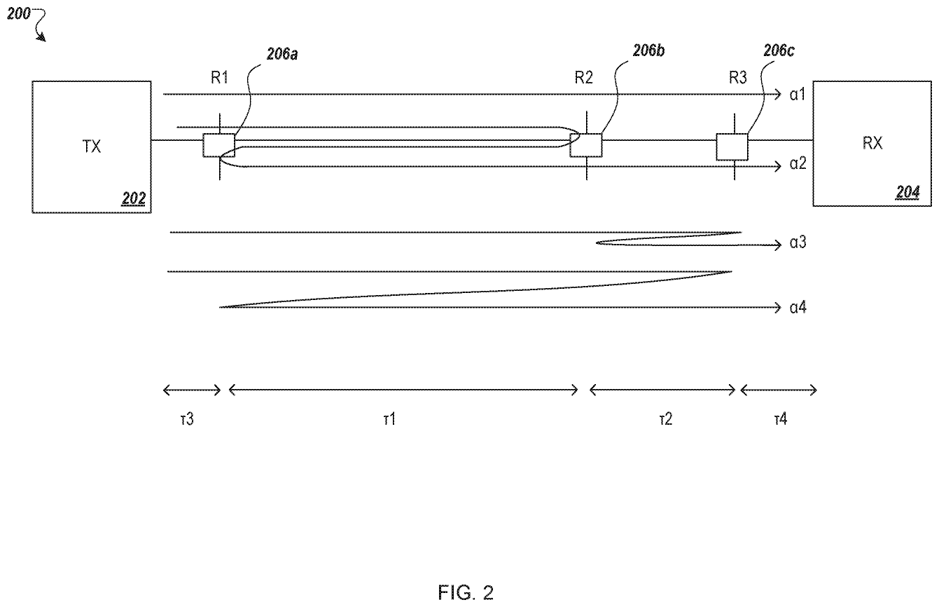

In some examples, FIG. 2 illustrates an example 200 of MPI between a transmitter 202 and a receiver 204. The distance between transmitter (TX) 202 and R1 206a may be τ3. The distance between R1 206a and R2 206b may be τ1. The distance between R2 206b and R3 206c may be τ2. The distance between R3 206c and receiver 204 may be τ4.

The receiver 204 may include a processing device. The processing device may measure a path delay of a signal; map the path delay to a connector-pair distance; and compute, at the receiver, a reflection location based on the connector-pair distance. The signal may be an amplitude modulation signal (e.g., a pulse amplitude modulation 4 signal or the like).

The processing device may compute, the MPI strength based on the path delay. The MPI strength may be the strength of the generated MPI that may be a function of relative light orientation between the main signal and MPI, on top of what may be adjusted with an optical attenuator. Theoretically, MPI may be fully orthogonal to the main path and be invisible at the RX side. Therefore, the effective MPI strength may be adjusted considering the effect of orientation (which is sensitive) and an algorithm may report the strength relative to the main signal power.

The system may monitor the double-reflection resulted path delay. The system may operate standalone at the receiver. However, this enables network operators maintaining a connector-fiber-length database to map the delay to a precise location as below (assuming different fiber-run-lengths between connectors in the plant).

In the example below, network operator may maintain a map of connector-pairs to distances—(i) {TX,R1}=>t₃; (ii) {R1,R2}=>t₁; (iii) {TX, R2}=>t₁+t₃; (iv) {R2,R3}=>t₂; (v) {R1,R3}=>t₁+t₂; (vi) {TX, R3}=>t₁+t₂+t₃; (vii) {R3,RX}=>t₄ (viii) {R2,RX}=>t₂+t₄; (ix) {R1,RX}=>t₁+t₂+t₄; (x) {TX, RX}=>t₁+t₂+t₃+t₄. Therefore, depending on the reflection distance of the localization function, the precise locations of reflection may be found.

Various parameters may be used in MPI detection and localization. For example, some of the parameters may include a path parameter, a lane bit map parameter, an enable parameter, a start scan parameter, an end scan parameter, a refractive index parameter, a line width parameter, a status code parameter, an MPI strength parameter, an MPI path length parameter, or the like. The path parameter may be the Rx or Tx path. The lane bit map parameter may set the lane ID. The enable parameter may enable or disable tone generation. The start scan parameter may be an MPI path length scanning start in meters. The end scan parameter may be an MPI path length scanning end in meters. The refractive index parameter may be e.g., 1.47. The line width parameter may be e.g., a range of 1 to 10 MHz, such as 5 MHz. The status code parameter may show an error type when processing a request.

A system may include a receiver and a transmitter. The transmitter may sound one or more connectors along a path to the receiver to facilitate detection of a faulty connector. The test transmitter may have a selected reflectance.

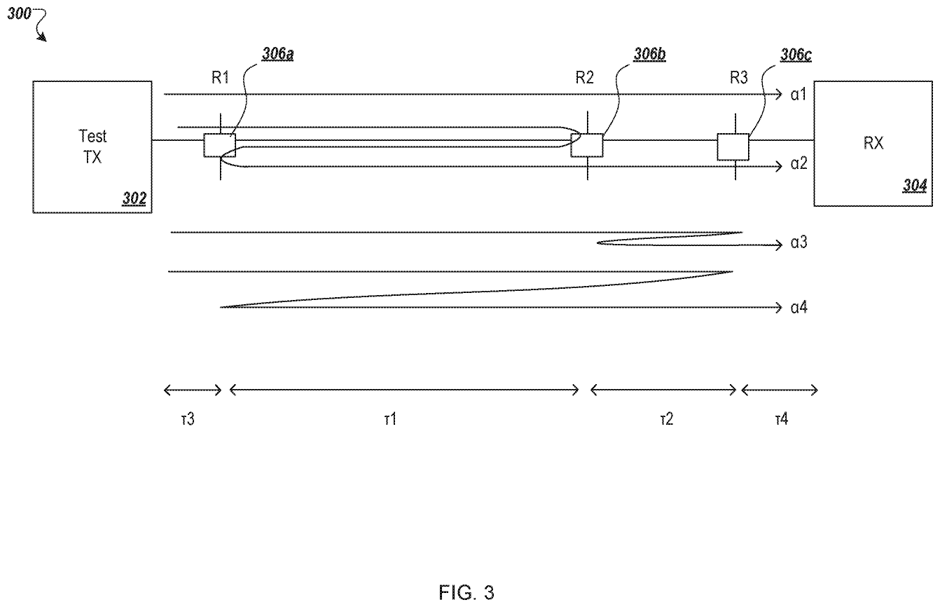

FIG. 3 illustrates an example 300 of a test transmitter 302, used for MPI detection and localization, in communication with a receiver 304. The test transmitter 302 may be used to located faulty connectors (e.g., R1 306a, or R2 306b, or R3 306c). Locating the high reflection connector (from a number of good connectors) under practical conditions may be useful. For a simple example, in a link including 4 to 6 connectors, two connectors may have measurable reflections. Among these, there may be one connector that may have a very high reflection and may be cleaned.

The algorithm may not find the exact location of this high reflection connector from the total 4 to 6 connectors because it may take a pair of connectors to create an MPI interference of level high enough to be detected and to impair the signal (a bad connector merely making the network more susceptible to the future occurrence of a second).

However, as a network commissioning step, a test transmitter 302 with high reflectance may be used to sound the connectors along the path, and the localization scheme may then detect a bad connector. The path delay may be mapped to the connector-pair distance using one or more of autocorrelation or periodic data capture.

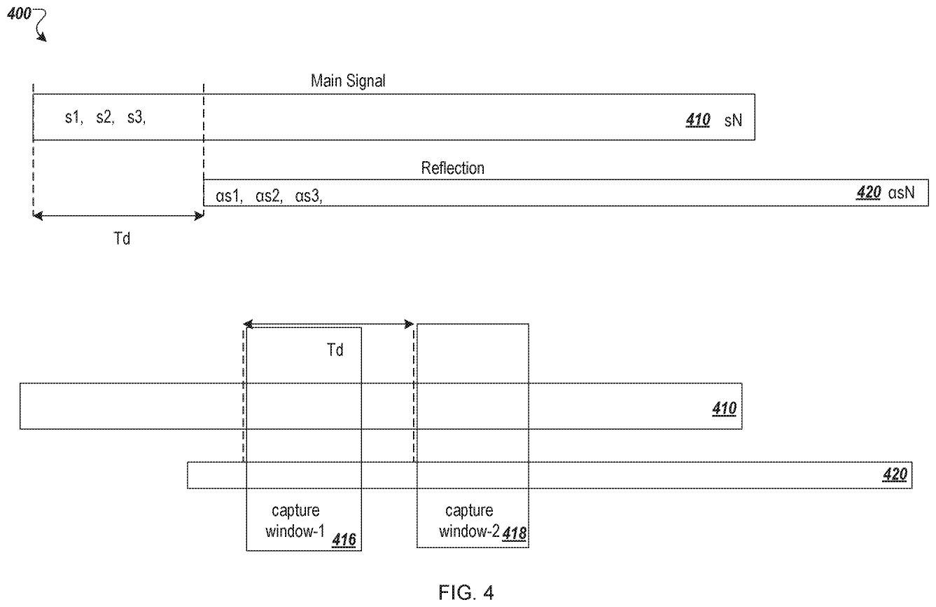

FIG. 4 illustrates an example 400 of MPI between a transmitter and a receiver. The transmitter may transmit a main signal 410 that may include e.g., s1, s2, s3, . . . , sN. The main signal 410 may be associated with MPI 420 that may include e.g., αs1, αs2, αs3, . . . , αsN. On the Rx side, the MPI 420 may look like a reflection with a long delay. The main signal 410 and the reflection (e.g., MPI 420) may be separated in time by T_{d}.

The cross-correlation of two captures spaced by Td may be used to detect this MPI 420. A first capture window 416 and a second capture window 418 may be captured. The beginning of the first capture window 416 may be spaced by Td from the beginning of the second capture window 418.

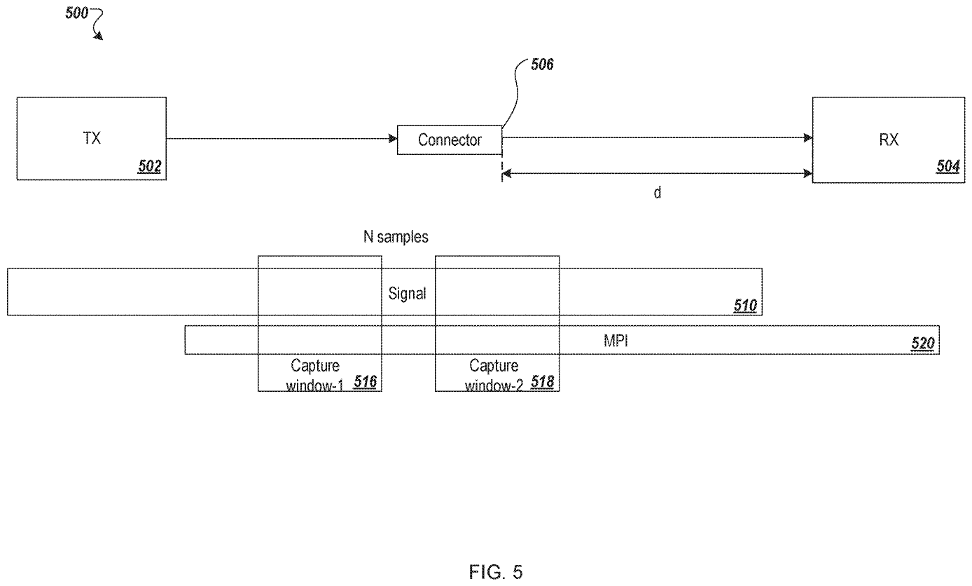

FIG. 5 illustrates an example 500 of data capture. A transmitter 502 may send a signal 510 to a receiver 504 and MPI 520 may be generated. A connector 506 may connect the transmitter 502 and the receiver 504. The distance between the connector 506 and the receiver 504 may be d. In some examples, d may be up to 3 km. Periodic capture e.g., using capture window-1 516 and/or capture window-2 518, may be used for distant reflections. The delay of the first reflection on RX side may be

$$\frac{2 d}{{c}^{′}} ,$$

where c is the speed of light (2e8 m/s in vacuum) and this may define the period of the capture. An algorithm may search an MPI starting from a given d₀ based on a search range R, i.e. may check reflections from connectors located between

$${d}_{0} - \frac{R}{2} and {d}_{0} + \frac{R}{2} .$$

Then, N may be calculated as

$$N = \frac{2 \times {d}_{0} \times 53 e 9}{2 e 8}$$

samples (for full rate case) and window sizes may be large enough to cover reflections from

$${d}_{0} \pm \frac{R}{2} .$$

If d is small and N is smaller than the window size, then regular capture may be used (for the full size capture, regular capture may be used when d<64 meters).

A processing device may compute the reflection location using one or more of a fixed width slicer algorithm, a sub-window cross correlation algorithm, an MPI search coverage expansion algorithm, or a peak detection algorithm.

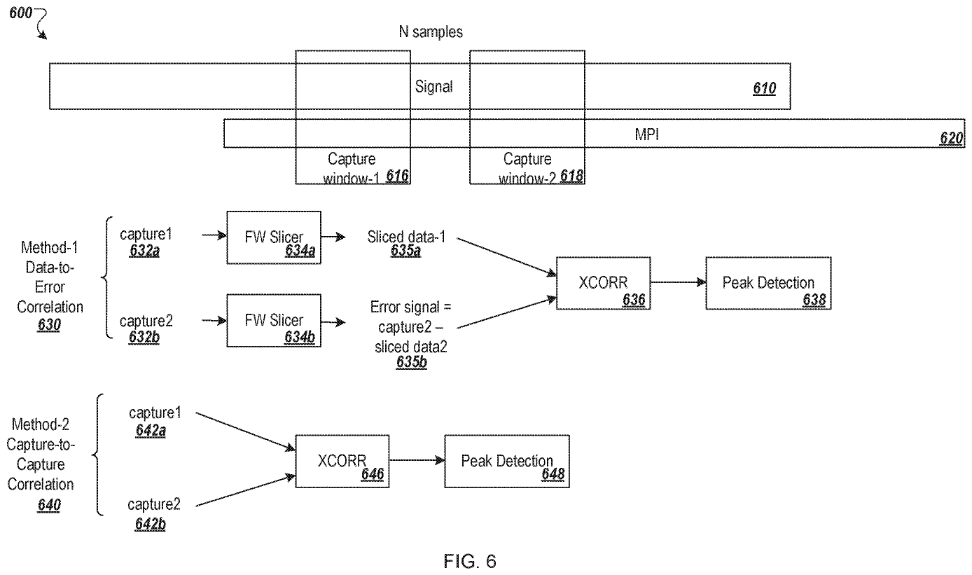

FIG. 6 illustrates a block diagram 600 of different algorithms used for MPI detection and localization. A signal 610 may be sent and MPI 620 may be generated. A first capture window 616 and a second capture 618 may be used in different methods using different algorithms.

In one method, data to error correlation 630 may be used. In this example, a first capture 632a may be used with a fixed width slicer 634a and a second capture 632a may be used with a fixed width slicer 634b. The sliced data (which may be sliced data 1 635a) and the error signal (which may be capture 2—sliced data2 635b) may be used with a sub-window cross correlation and averaging algorithm 636. The result may be used with a peak detection algorithm 638.

In another method, capture to capture correlation 640 may be used. A first capture 642a and a second capture 642b may be used with sub-window cross correlation and an averaging algorithm 646. The result may be used with a peak detection algorithm 648.

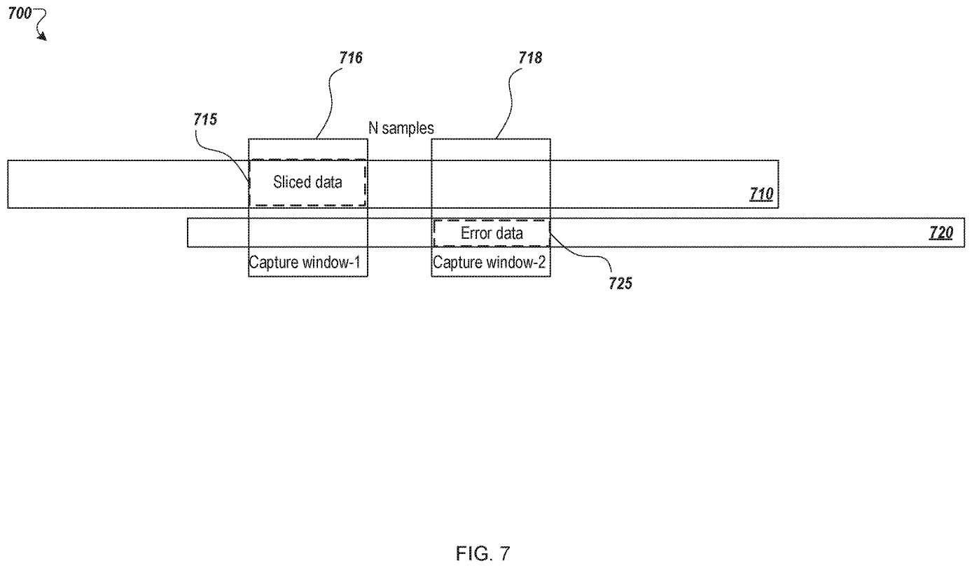

FIG. 7 illustrates an example 700 of the functionality of the fixed width (FW) slicer algorithm. The FW slicer algorithm may be used for MPI requests to be processed in cases where the clock recovery unit (CRU) locks and the signal is equalized.

During cross correlation, the original signal 710 and the reflection (e.g., MPI 720) may be correlated. A first capture window 716 and a second capture window 718 may be captured. Any unnecessary component on the captured data may create a boosted noise floor which may degrade MPI detection performance. This algorithm may compute the sliced pulse amplitude modulation (PAM)-4 symbols (levels) (e.g., sliced data 715) and error signal from the captured data (e.g., error data 725). Slicer thresholds and outputs may be used for computation.

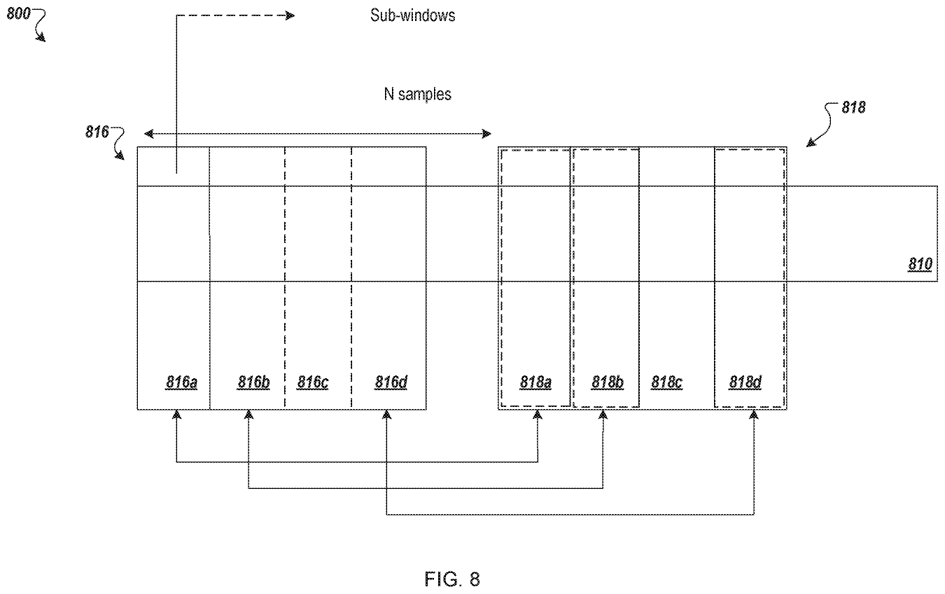

FIG. 8 illustrates an example 800 of sub-window cross correlation and averaging algorithm. Capture windows 816, 818 may be partitioned into sub-windows (e.g., capture window 816 may have sub-windows 816a, 816b, 816c, 816d and capture window 818 may have sub-windows 818a, 818b, 818c, 818d), and the sub-window of window-1 (e.g., sub-windows 816a, 816b, 816c, 816d) and window-2 (e.g., sub-windows 818a, 818b, 818c, 818d) may be correlated with each other. Then the cross correlation of the sub-windows may be averaged.

Time varying phase may cause a very low correlation if capture sizes are larger than the laser coherence time. Captured windows may be partitioned to the sub-windows (sub-windows can have some overlapping with each other) to reduce the effect of time varying phase. Sub-windows may be cross-correlated, and their cross-correlations may be averaged. However, cross correlation of the sub-windows may have a different polarity and during averaging they may cancel each other. Therefore, the peak of the cross correlation may be multiplied by its sign before averaging.

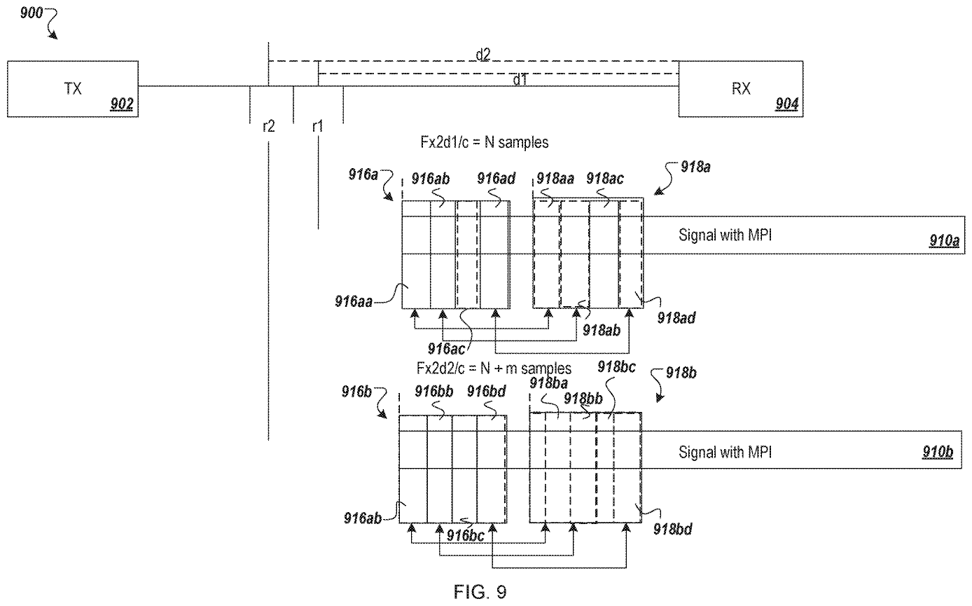

FIG. 9 illustrates an example of the MPI search coverage expansion algorithm. This algorithm may re-use the same capture for checking the MPI in different ranges by adjusting the distance of sub-windows in window-1 and window-2. When searching in sub-region r1, the first capture window 916a and the second capture window 918a may be divided into sub-windows (e.g., first capture window 916a may include sub-windows 916aa, 916ab, 916ac, 916ad and second capture window 918a may include sub-windows 918aa, 918ab, 918ac, 918ad). When searching in sub-region r2, the first capture window 916b and the second capture window 918b may be divided into sub-windows (e.g., first capture window 916b may include sub-windows 916ba, 916bb, 916bc, 916bd and second capture window 918b may include sub-windows 918ba, 918bb, 918bc, 918bd).

The distance may be increased between sub-windows of two main windows to check a different region (e.g., region r1 and/or region r2) with the same captured data. This way search coverage may be expanded without doing a new capture.

In another example, a peak detection algorithm may be used. The peak detection algorithm may detect the peak and location of MPI on the averaged cross correlation of sub-windows. In some examples, a peak detection algorithm may apply an adaptive thresholding by considering the moving mean of the noise floor. With a moving window, algorithm keeps updating mean and std deviation, and detects the peak if a sample exceeds (threshold×stdDev) after removing the mean.

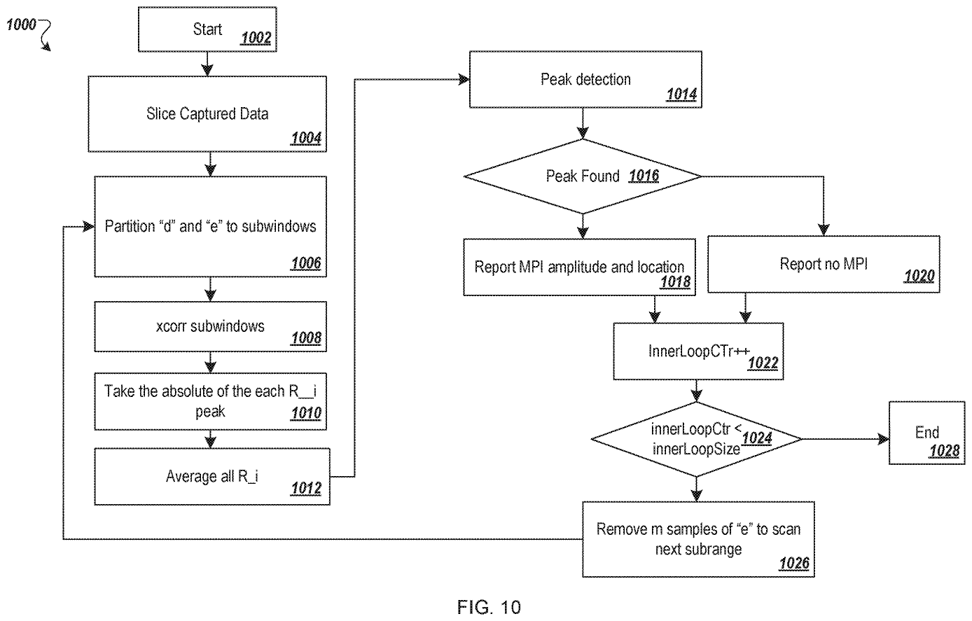

FIG. 10 illustrates an example algorithm flow 1000. The functionality may include one or more of slicing captured data, partitioning into sub-windows, cross correlating the sub-windows, taking the absolute of the R_i peak, averaging the R_i peaks, detecting the peaks, reporting MPI, and so forth.

The algorithm flow 1000 may start in operation 1002. Captured data may be sliced, as shown in operation 1004. The captured data may be the sliced data and the error data. The sliced data may be “d” which may be the sliced data of a first window (e.g., w1). The error data may be “e” which may be the error data of the second window (e.g., w2).

The sliced data and the error data may be partitioned to sub-windows, as shown in operation 1006. For example, “d” may be partitioned to be d_1, d_2, . . . , d_n. For example, “e” may be partitioned to be e_1, e_2, . . . , e_n.

The autocorrelation of the sub-windows may be computed, as shown in operation 1008. The cross correlation, R_i may be computed using the cross correlation of R(d_i, e_i). The absolute of each R_i peak may be taken, as shown in operation 1010, and the average of R_i may be computed, as shown in operation 1012.

Peak detection may be used, as shown in operation 1014. When a peak is found, as shown in operation 1016, the MPI amplitude and location may be reported, as shown in operation 1018. When a peak is not found, then no MPI may be reported, as shown in operation 1020. An inner loop counter may be incremented as shown in operation 1022. When the inner loop counter is less than the inner loop size, as shown in operation 1024, then m samples are removed from “e” to scan the next sub-range, as shown in operation 1026. When the inner loop counter is not less than the inner loop size, then the algorithm flow 1000 ends, as shown in operation 1028.

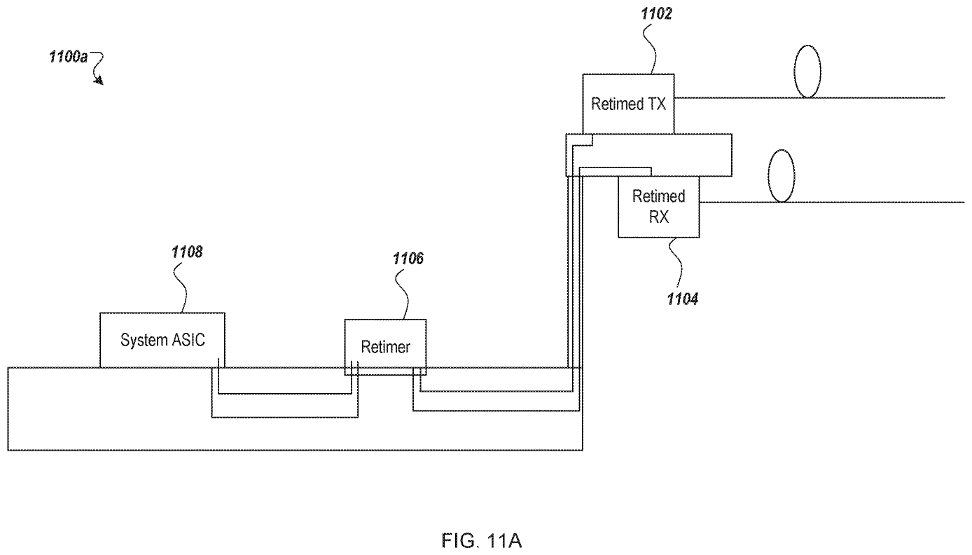

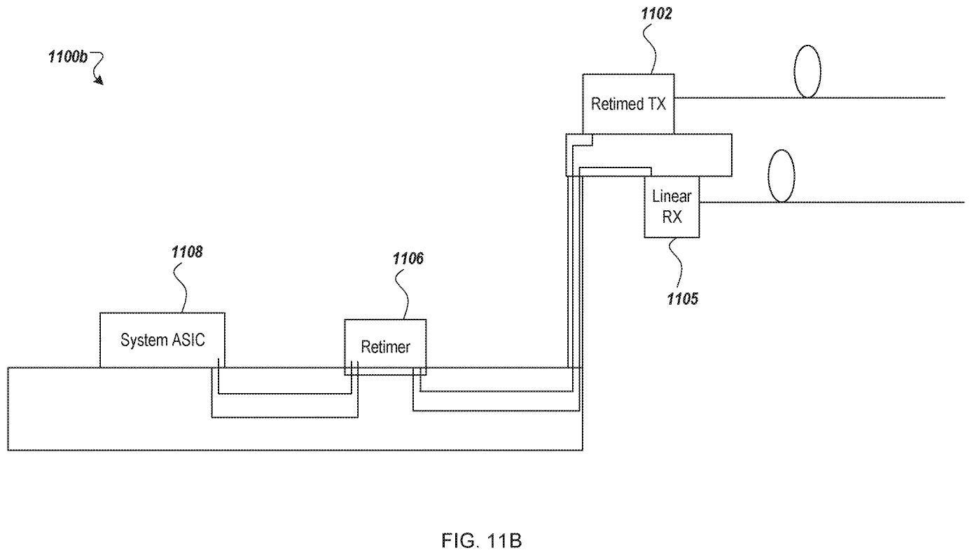

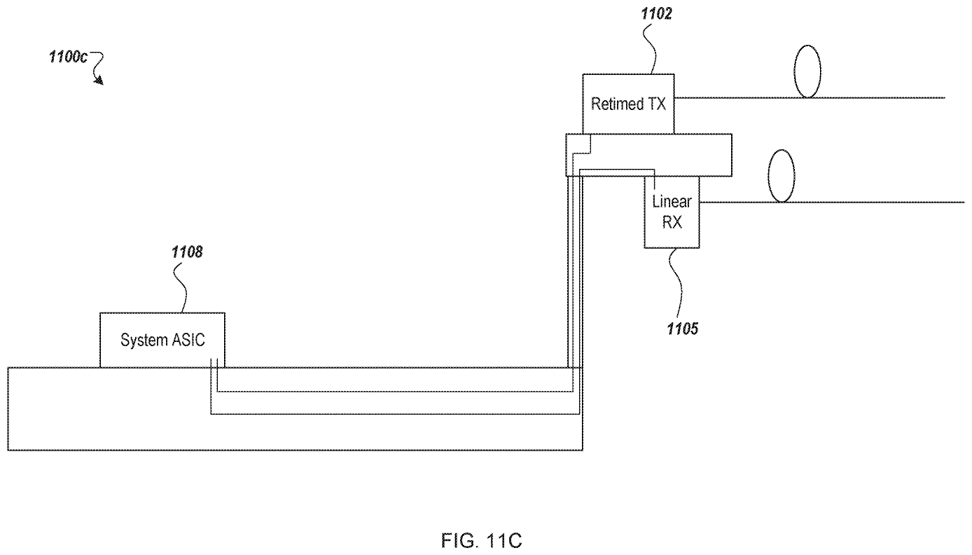

As illustrated in the architecture 1100a in FIG. 11A, MPI detection and localization may be performed with retimed pluggable modules. A system may include a pluggable module. The pluggable module may include a retimed transmitter 1102. The pluggable module may include a retimed receiver 1104. The retimed transmitter 1102 may be coupled to a retimer 1106. The retimed receiver 1104 may be coupled to the retimer 1106. The retimer 1106 may be coupled to a system ASIC 1108. The system may include an on-board component that may include the system ASIC 1108. There may be up to 32 dB of loss between the one or more of the retimed transmitter 1102 or the retimed receiver 1104 and the retimer 1106.

In this example, MPI detection and localization may be performed at the retimed receiver 1104. The retimed receiver 1104 may measure a path delay of a signal, map the path delay to a connector-pair distance, and compute a reflection location based on the connector-pair distance.

As illustrated in the architecture 1100b in FIG. 11B, MPI detection and localization may be performed with a half-retimed pluggable module with an on-board retimer. The system may include a retimed transmitter 1102, a linear receiver 1105, a retimer 1106, and a system ASIC 1108. The linear receiver 1105 may be coupled to the retimer 1106.

In this example, MPI detection and localization may be performed at the retimer 1106. The retimer 1106 may measure a path delay of a signal, map the path delay to a connector-pair distance, and compute a reflection location based on the connector-pair distance.

As illustrated in the architecture 1100c in FIG. 11C, MPI detection and localization may be performed with a half-retimed pluggable module without an on-board retimer. The system may include a retimed transmitter 1102, a linear receiver 1105, and a system ASIC 1108. The linear receiver 1105 may be coupled to the system ASIC 1108. The retimed transmitter 1102 may be coupled to the system ASIC 1108.

In this example, MPI detection and localization may be performed at the system ASIC 1108. The system ASIC 1108 may measure a path delay of a signal, map the path delay to a connector-pair distance, and compute a reflection location based on the connector-pair distance.

In some examples, one or more of the pluggable module (e.g., including the retimed transmitter 1102 or the retimed receiver 1104) or the on-board component (e.g., including the retimer 1106 or the system ASIC 1108) may compute an MPI strength based on the path delay.

The path delay may be mapped to the connector-pair distance using various methods such as by using a connector-fiber-length database, autocorrelation, and/or periodic data capture and/or various algorithms such as a fixed width slicer algorithm, a sub-window cross correlation algorithm, an MPI search coverage expansion algorithm, or a peak detection algorithm.

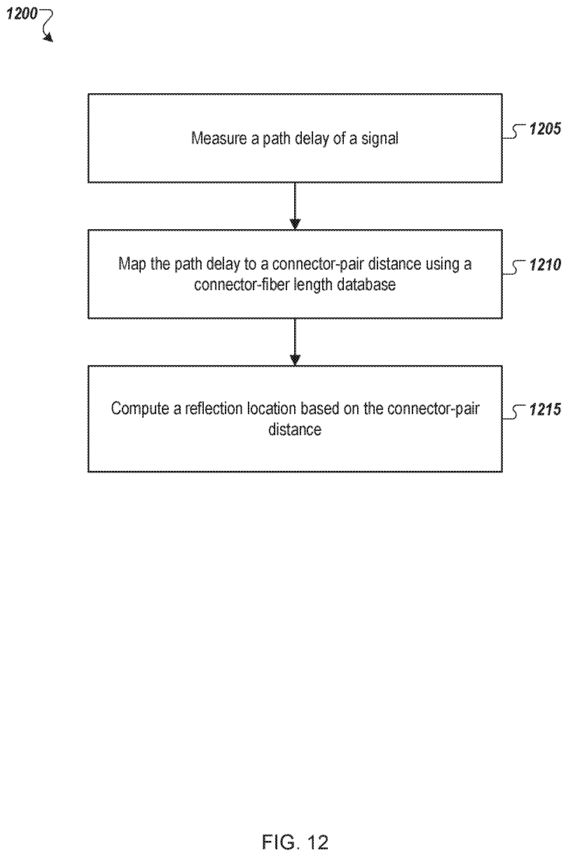

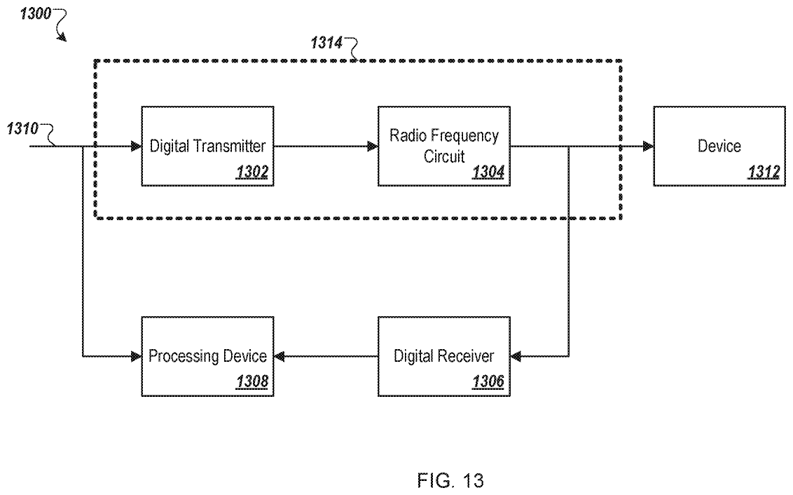

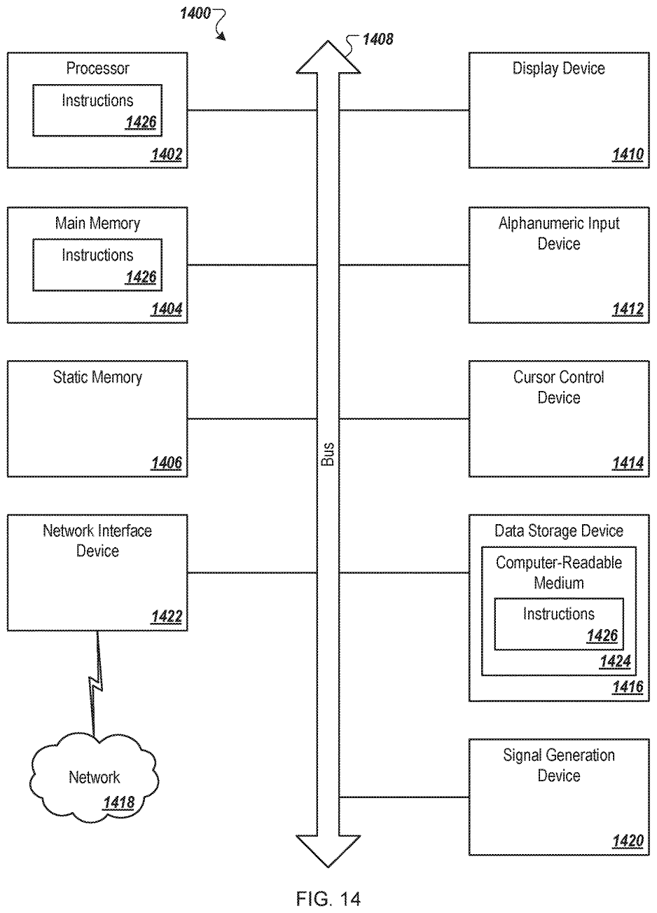

FIG. 12 illustrates a process flow of an example method 1200 of MPI detection and localization, in accordance with at least one example described in the present disclosure. The method 1200 may be arranged in accordance with at least one example described in the present disclosure. The method 1200 may be performed by processing logic that may include hardware (circuitry, dedicated logic, etc.), software (such as is run on a computer system or a dedicated machine), or a combination of both, which processing logic may be included in the processing device 1402 of FIG. 14, the communication system 1300 of FIG. 13, or another device, combination of devices, or systems.

The method 1200 may begin at block 1205 where the processing logic may measure a path delay of a signal.

At block 1210, the processing logic may map the path delay to a connector-pair distance.

At block 1215, the processing logic may compute a reflection location based on the connector-pair distance.

Modifications, additions, or omissions may be made to the method 1200 without departing from the scope of the present disclosure. For example, in some examples, the method 1200 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 13 illustrates a block diagram of an example communication system 1300 MPI detection and localization, in accordance with at least one example described in the present disclosure. The communication system 1300 may include a digital transmitter 1302, a radio frequency circuit 1304, a device 1312, a digital receiver 1306, and a processing device 1308. The digital transmitter 1302 and the processing device 1308 may receive a baseband signal via connection 1310. A transceiver 1314 may comprise the digital transmitter 1302 and the radio frequency circuit 1304.

In some examples, the communication system 1300 may include a system of devices that may communicate with one another via a wired or wireline connection. For example, a wired connection in the communication system 1300 may include one or more Ethernet cables, one or more fiber-optic cables, and/or other similar wired communication mediums. Alternatively, or additionally, the communication system 1300 may include a system of devices that may communicate via one or more wireless connections. For example, the communication system 1300 may include one or more devices that may transmit and/or receive radio waves, microwaves, ultrasonic waves, optical waves, electromagnetic induction, and/or similar wireless communications. Alternatively, or additionally, the communication system 1300 may include combinations of wireless and/or wired connections. In these and other examples, the communication system 1300 may include one or more devices that may obtain a baseband signal, perform one or more operations to the baseband signal to generate a modified baseband signal, and transmit the modified baseband signal, such as to one or more loads.

In some examples, the communication system 1300 may include one or more communication channels that may communicatively couple systems and/or devices included in the communication system 1300. For example, the transceiver 1314 may be communicatively coupled to the device 1312.

In some examples, the transceiver 1314 may obtain a baseband signal. For example, as described herein, the transceiver 1314 may generate a baseband signal and/or receive a baseband signal from another device. In some examples, the transceiver 1314 may transmit the baseband signal. For example, upon obtaining the baseband signal, the transceiver 1314 may transmit the baseband signal to a separate device, such as the device 1312. Alternatively, or additionally, the transceiver 1314 may modify, condition, and/or transform the baseband signal in advance of transmitting the baseband signal. For example, the transceiver 1314 may include a quadrature up-converter and/or a digital to analog converter (DAC) that may modify the baseband signal. Alternatively, or additionally, the transceiver 1314 may include a direct radio frequency (RF) sampling converter that may modify the baseband signal.

In some examples, the digital transmitter 1302 may obtain a baseband signal via connection 1310. In some examples, the digital transmitter 1302 may up-convert the baseband signal. For example, the digital transmitter 1302 may include a quadrature up-converter to apply to the baseband signal. In some examples, the digital transmitter 1302 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 1302.

In some examples, the transceiver 1314 may include one or more subcomponents that may be used in preparing the baseband signal and/or transmitting the baseband signal. For example, the transceiver 1314 may include an RF front end (e.g., in a wireless environment) which may include a power amplifier (PA), a digital transmitter (e.g., 1302), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 1304) of the transceiver 1314 may be synchronized with the resource controller via the S-plane device, which may contribute to high-accuracy timing with respect to a reference clock.

In some examples, the transceiver 1314 may obtain the baseband signal for transmission. For example, the transceiver 1314 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 1314 may generate a baseband signal for transmission. In these and other examples, the transceiver 1314 may transmit the baseband signal to another device, such as the device 1312.

In some examples, the device 1312 may receive a transmission from the transceiver 1314. For example, the transceiver 1314 may transmit a baseband signal to the device 1312.

In some examples, the radio frequency circuit 1304 may transmit the digital signal received from the digital transmitter 1302. In some examples, the radio frequency circuit 1304 may transmit the digital signal to the device 1312 and/or the digital receiver 1306. In some examples, the digital receiver 1306 may receive a digital signal from the RF circuit and/or send a digital signal to the processing device 1308.

In some examples, the processing device 1308 may be a standalone device or system, as illustrated. Alternatively, or additionally, the processing device 1308 may be a component of another device and/or system. For example, in some examples, the processing device 1308 may be included in the transceiver 1314. In instances in which the processing device 1308 is a standalone device or system, the processing device 1308 may communicate with additional devices and/or systems remote from the processing device 1308, such as the transceiver 1314 and/or the device 1312. For example, the processing device 1308 may send and/or receive transmissions from the transceiver 1314 and/or the device 1312. In some examples, the processing device 1308 may be combined with other elements of the communication system 1300.

FIG. 14 illustrates a diagrammatic representation of a machine in the example form of a computing device 1400 within which a set of instructions, for causing the machine to perform any one or more of the methods discussed herein, may be executed. The computing device 1400 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1400 includes a processing device (e.g., a processor) 1402, a main memory 1404 (e.g., read-only memory (ROM), flash memory, dynamic random access memory (DRAM) such as synchronous DRAM (SDRAM)), a static memory 1406 (e.g., flash memory, static random access memory (SRAM)) and a data storage device 1416, which communicate with each other via a bus 1408.

Processing device 1402 represents one or more general-purpose processing devices such as a microprocessor, central processing unit, or the like. More particularly, the processing device 1402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1402 may also include one or more special-purpose processing devices such as an application specific integrated circuit (ASIC), a field programmable gate array (FPGA), a digital signal processor (DSP), network processor, or the like. The processing device 1402 is configured to execute instructions 1426 for performing the operations and steps discussed herein.

The computing device 1400 may further include a network interface device 1422 which may communicate with a network 1418. The computing device 1400 also may include a display device 1410 (e.g., a liquid crystal display (LCD) or a cathode ray tube (CRT)), an alphanumeric input device 1412 (e.g., a keyboard), a cursor control device 1414 (e.g., a mouse) and a signal generation device 1420 (e.g., a speaker). In at least one example, the display device 1410, the alphanumeric input device 1412, and the cursor control device 1414 may be combined into a single component or device (e.g., an LCD touch screen).

The data storage device 1416 may include a computer-readable storage medium 1424 on which is stored one or more sets of instructions 1426 embodying any one or more of the methods or functions described herein. The instructions 1426 may also reside, completely or at least partially, within the main memory 1404 and/or within the processing device 1402 during execution thereof by the computing device 1400, the main memory 1404 and the processing device 1402 also constituting computer-readable media. The instructions may further be transmitted or received over a network 1418 via the network interface device 1422.

While the computer-readable storage medium 1424 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A method for multi-path interference (MPI) detection and localization, comprising:
measuring a path delay of a signal;
mapping the path delay to a connector-pair distance; and
computing a reflection location based on the connector-pair distance.

2. The method of claim 1, further comprising:
sounding, using a test transmitter, one or more connectors along a path, wherein the test transmitter has a selected reflectance, to facilitate detection of a faulty connector.

3. The method of claim 1, further comprising:
computing an MPI strength based on the path delay.

4. The method of claim 1, wherein the signal is an amplitude modulation signal.

5. The method of claim 1, wherein the path delay is mapped to the connector-pair distance using a connector-fiber-length database.

6. The method of claim 1, wherein the path delay is mapped to the connector-pair distance using autocorrelation.

7. The method of claim 1, wherein the path delay is mapped to the connector-pair distance using periodic data capture.

8. The method of claim 1, further comprising:
computing the reflection location using one or more of a fixed width slicer algorithm, a sub-window cross correlation algorithm, an MPI search coverage expansion algorithm, or a peak detection algorithm.

9. A device, comprising:
a processing device operable to:
measure, at the device, a path delay of a signal;
map, at the device the path delay to a connector-pair distance; and
compute, at the device, a reflection location based on the connector-pair distance.

10. The device of claim 9, wherein the processing device is further operable to:
compute, at the device, an MPI strength based on the path delay.

11. The device of claim 9, wherein the signal is an amplitude modulation signal.

12. The device of claim 9, wherein the path delay is mapped to the connector-pair distance using a connector-fiber-length database.

13. The device of claim 9, wherein the path delay is mapped to the connector-pair distance using autocorrelation or periodic data capture.

14. The device of claim 9, wherein the processing device is further operable to:
compute, at the device, the reflection location using one or more of a fixed width slicer algorithm, a sub-window cross correlation algorithm, an MPI search coverage expansion algorithm, or a peak detection algorithm.

15. The device of claim 9, wherein the device is one or more of a retimed receiver, a retimer, or a system application-specific integrated circuit (ASIC).

16. A system, comprising:
a pluggable module comprising:
a retimed transmitter; and
one or more of a retimed receiver or a linear receiver; and
an on-board component comprising a system application-specific integrated circuit (ASIC),
wherein one or more of the pluggable module or the on-board component is operable to:
measure a path delay of a signal;
map the path delay to a connector-pair distance; and
compute a reflection location based on the connector-pair distance.

17. The system of claim 16, wherein the on-board component further comprises a retimer.

18. The system of claim 16, wherein one or more of the pluggable module or the on-board component is operable to compute an MPI strength based on the path delay.

19. The system of claim 16, wherein the path delay is mapped to the connector-pair distance using one or more of a connector-fiber-length database, autocorrelation, or periodic data capture.

20. The system of claim 16, wherein one or more of the pluggable module or the on-board component is operable to compute the reflection location using one or more of a fixed width slicer algorithm, a sub-window cross correlation algorithm, an MPI search coverage expansion algorithm, or a peak detection algorithm.
